(19) United States
(12) Patent Application Publication
(10) Pub. No.: US 2025/0334491 A1
(43) Pub. Date: Oct. 30, 2025

(54) Methods, Systems, and Devices for Preparing a Biological Sample

(71) Applicant: IDEXX Laboratories, Inc., Westbrook, ME (US)

(72) Inventors: Michael Schrameyer, Portland, ME (US); Michael P. Stone, Falmouth, ME (US)

(73) Assignee: IDEXX Laboratories, Inc., Westbrook, ME (US)

(21) Appl. No.: 19/169,424

(22) Filed: Apr. 3, 2025

Related U.S. Application Data
(60) Provisional application No. 63/638,784, filed on Apr. 25, 2024.

(51) Int. Cl. G01N 1/28; B01L 3/00

(52) U.S. Cl. CPC G01N 1/28; B01L 3/502; B01L 3/52; B01L 2300/044; B01L 2300/0681; B01L 2300/0861

(57) ABSTRACT

A device for preparing a biological sample. The device includes a receiving chamber. The device also includes a buffer chamber, wherein the buffer chamber comprises a fluid buffer and a first fluidic communication mechanism between the receiving chamber and the buffer chamber. The device also includes a filter chamber, wherein the filter chamber comprises a porous membrane, and wherein the buffer chamber comprises a second fluidic communication mechanism between the buffer chamber and the filter chamber. The device further includes a reagent reservoir, wherein the reagent reservoir comprises a fluid reagent and a third fluidic communication mechanism between the filter chamber and the reagent reservoir.

### CROSS-REFERENCE TO RELATED APPLICATIONS

This application claims the benefit of co-pending U.S. Provisional Patent Application Ser. No. 63/638,784, filed Apr. 25, 2024, which is hereby incorporated by reference in its entirety.

### FIELD OF THE DISCLOSURE

The present disclosure involves devices, systems, and methods for preparing a biological sample for testing.

### BACKGROUND

Preparing a biological sample for testing typically involves mixing the biological sample with a fluid buffer and/or diluent and introducing a reagent to the mixture prior to analysis.

### SUMMARY

In an example, a device for preparing a biological sample for testing is disclosed. The device includes a receiving chamber. The device also includes a buffer chamber, wherein the buffer chamber comprises a fluid buffer and a first fluidic communication mechanism between the receiving chamber and the buffer chamber. The device additionally includes a filter chamber, wherein the filter chamber comprises a porous membrane, and wherein the buffer chamber comprises a second fluidic communication mechanism between the buffer chamber and the filter chamber. The device also includes a reagent reservoir, wherein the reagent reservoir comprises a fluid reagent and a third fluidic communication mechanism between the filter chamber and the reagent reservoir.

In another example, a method for preparing a biological sample for testing is disclosed. The method includes receiving a biological sample in a receiving chamber. The method also includes displacing and emulsifying the biological sample from the receiving chamber to a buffer chamber via a first fluidic communication mechanism, the buffer chamber comprising a fluid buffer. The method also includes displacing the emulsified biological sample from the buffer chamber to a filter chamber via a second fluidic communication mechanism, wherein the filter chamber comprises a porous membrane. The method also includes filtering the emulsified biological sample via the porous membrane. The method additionally includes displacing the emulsified and clarified biological sample from the filter chamber to a reagent reservoir via a third fluidic communication mechanism, the reagent reservoir comprising a fluid reagent.

In another example, a system for testing a biological sample is disclosed. The system includes a device for preparing the biological sample for testing. The device includes a receiving chamber. The device also includes a buffer chamber, wherein the buffer chamber comprises a fluid buffer and a first fluidic communication mechanism between the receiving chamber and the buffer chamber. The device additionally includes a filter chamber, wherein the filter chamber comprises a porous membrane, and wherein the buffer chamber comprises a second fluidic communication mechanism between the buffer chamber and the filter chamber. The device also includes a reagent reservoir, wherein the reagent reservoir comprises a fluid reagent and a third fluidic communication mechanism between the filter chamber and the reagent reservoir. The system additionally includes an imaging device. The imaging device includes an imaging sensor configured to capture one or more images of the biological sample. The imaging device additionally includes a computing device configured to analyze the captured one or more images.

In another example, a device for testing a biological sample is disclosed. The device includes a receiving chamber, wherein the receiving chamber is configured to receive a biological sample. The device also includes a buffer chamber, wherein the buffer chamber comprises a fluid buffer and is in fluidic communication with the receiving chamber. The device also includes a filter configured to filter the biological sample, wherein the buffer chamber comprises a first fluidic communication mechanism between the buffer chamber and the filter. The device also includes a reagent channel, wherein the reagent channel comprises a reagent pack comprises a fluid reagent, wherein the reagent channel is in fluidic communication with the filter. The device also includes a test strip configured to provide a fluidic communication between the reagent channel and an absorbent pad and support a directional flow of the biological sample and the fluid reagent from the reagent channel to the absorbent pad.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates a device for preparing a biological sample for testing, according to an example embodiment.

FIG. 2B illustrates a device for preparing a biological sample for testing, according to an example embodiment.

FIG. 2C illustrates a device for preparing a biological sample for testing, according to an example embodiment.

FIG. 2D illustrates a device for preparing a biological sample for testing with an actuator, according to an example embodiment.

FIG. 3A illustrates a device for preparing and testing a biological sample, according to an example embodiment.

FIG. 3B illustrates a device for preparing and testing a biological sample, according to an example embodiment.

FIG. 3C illustrates an actuator, according to an example embodiment.

FIG. 4 illustrates a computing system configured for use with an imaging device and a mobile computing device, according to an example embodiment.

FIG. 5 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to devices, systems, and methods for preparing a biological sample for testing.

Testing and/or analyzing, as referred to herein, may include, for example, capturing one or more images related to a biological sample. For example, testing can involve capturing images of a biological sample from an imaging sensor and determining a stain intensity. In examples, testing can further involve modifying an intensity of a light source, then capturing one or more additional images from the imaging sensor. One or more machine learning models can then be implemented to analyze the captured images and perform one or more computational actions, including identifying a characteristic of the biological sample.

In another example, these images may come from competitive immunoassays for detection of antibodies in the biological sample and a competitive immunoassay may be carried out in the following illustrative manner. A sample (e.g. from an animal's body fluid) potentially containing an antibody of interest that is specific for an antigen, is contacted with the antigen attached to the particle and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a competitive immunoassay, a sample (e.g. from an animal's body fluid) potentially containing an analyte, is contacted with the analyte conjugated to a detectable label and with an anti-analyte antibody attached to the particle. The antigen in the sample competes with analyte conjugated to the label for binding to the antibody attached the particle. The amount of the label associated with the particles can then be determined after separating unbound antigen and label. The signal obtained is inversely related to the amount of analyte present in the sample.

Antibodies, antigens, and other binding members (e.g., aptamers) may be attached to the particle or to the label directly via covalent binding with or without a linker or may be attached through a separate pair of binding members as is well known (e.g., biotin: streptavidin, digoxigenin: anti-digoxiginen). In addition, while the examples herein reflect the use of immunoassays, the particles and methods of the disclosure may be used in other receptor binding assays, including nucleic acid hybridization assays, that rely on immobilization of one or more assay components to a solid phase.

Generally, preparing a biological sample from solid or semi-solid biological materials (e.g., fecal matter) for such testing involves mixing and emulsifying the biological sample into a buffer, passing the biological sample through a filter, and introducing one or more reagents to the mixture of the biological sample and the buffer prior to imaging, testing, and/or other analytical methods. The combination of the biological sample, the buffer, and the reagent can then be deposited onto a testing surface (e.g., a slide or cartridge) for testing, such as imaging.

To date, such devices and methods for preparing a biological testing sample require significant manual user handling. Historically, preparation of a biological sample for testing involves a user (e.g., a clinician) manually measuring and handling the buffer to be mixed with the biological sample. Similarly, the preparation may involve the user manually handling and measuring a liquid reagent to agitate and mix with the liquid diluent and biological sample. This process can be time intensive, result in user error in measurement and handling, and produce waste from these potential user errors.

Moreover, handling certain types of crude samples can be particularly problematic. Fecal samples, for instance, can contain harmful pathogens, including bacteria, viruses, and parasites, which can pose health risks to users handling them. As such, fecal samples can contaminate surfaces, equipment, and other samples if not handled properly. This contamination can compromise the accuracy of test results and pose risks to laboratory personnel and others who come into contact with the contaminated items. Additionally, the consistency of fecal samples can vary greatly between samples (e.g., a dehydrated fecal sample, a fluid fecal sample, etc.). Further, fecal samples typically have a strong, unpleasant odor.

The example systems, devices, and methods disclosed herein address some of these issues. An example device of the present disclosure contains a series of chambers, each of which has a role in preparing the biological sample for testing. The chambers include compliant material so that the biological sample can be moved through each of these chambers by way of compressing the respective exteriors. Particularly, compression of a chamber can actuate a fluidic communication mechanism (e.g., one or more fluid paths that are controlled and/or limited by one or more pierceable covers, seals, valves, etc.) to provide a fluidic communication to the next chamber. Embodiments can include manual and/or automated actuation.

For instance, the biological sample can be received in a receiving chamber. Compression of the receiving chamber can mobilize and/or otherwise force the biological sample through a first fluidic communication mechanism to a buffer chamber. The buffer chamber includes an on-board fluid buffer to mix with the biological sample. The buffer chamber can be compressed to move the biological sample to a filter chamber via a second fluidic communication mechanism. The filter chamber can include a porous membrane to clarify the biological sample. The biological sample can then be moved to a reagent chamber via a third fluidic communication mechanism. The reagent chamber includes one or more on-board reagents to mix with the biological sample.

Some example devices are compatible with and/or include an integrated cartridge. For instance, the reagent chamber can be in fluidic communication with a cartridge for imaging. This integration further limits user interaction with the biological sample and prevents contamination and/or loss of volume of the biological sample. Further, in this manner, the device can prepare the biological sample for a number of different imaging protocols (e.g., a microfluidic assay, a lateral flow assay, an Electrowetting-on-Dielectric (EWOD) assay, an assay using bar-coded magnetic beads, an immunoassay, a polymerase chain reaction (PCR) assay, etc.).

Some example devices perform on-board testing of the biological sample by way of a test strip. For instance, once the biological sample travels through the series of chambers, one or more test strips can support lateral flow of the biological sample. The one or more test strips can perform one or more tests on the biological sample.

Example devices can reduce waste because they collect, meter, and mix biological samples on a single device and can include packaging made of sustainable materials at reduced mass for disposal and low-cost manufacturing methods.

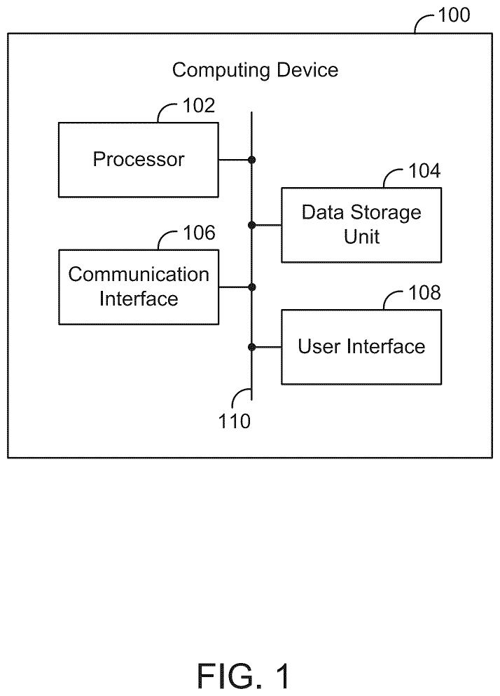

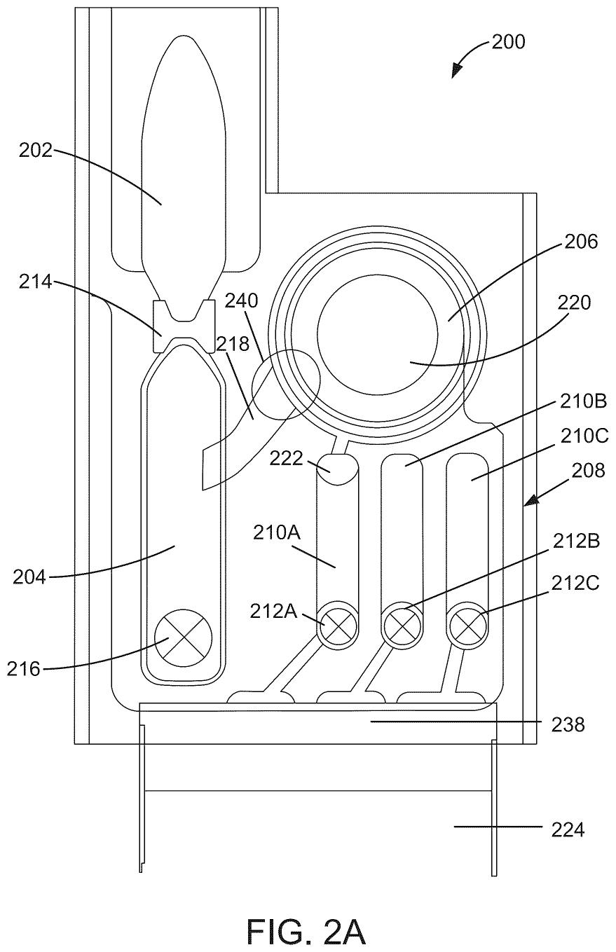

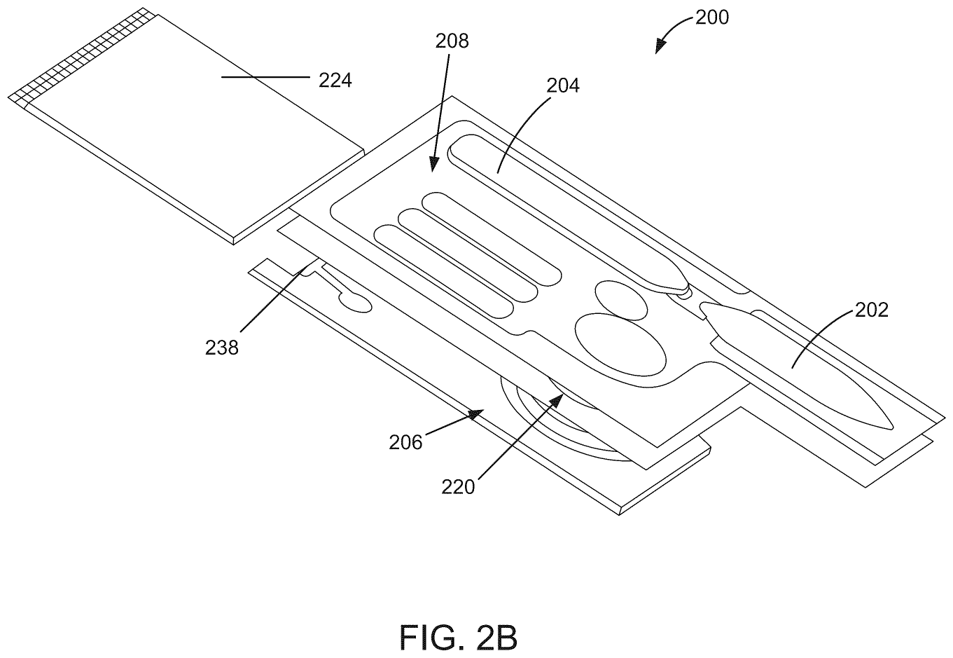

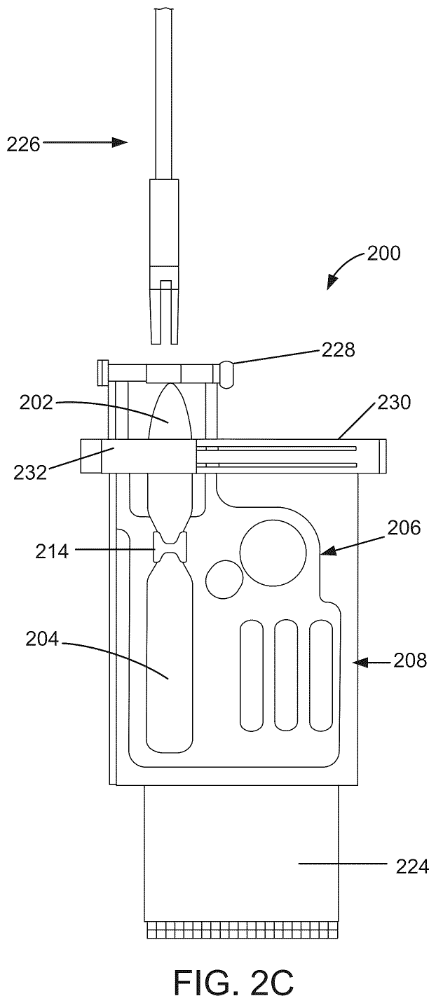

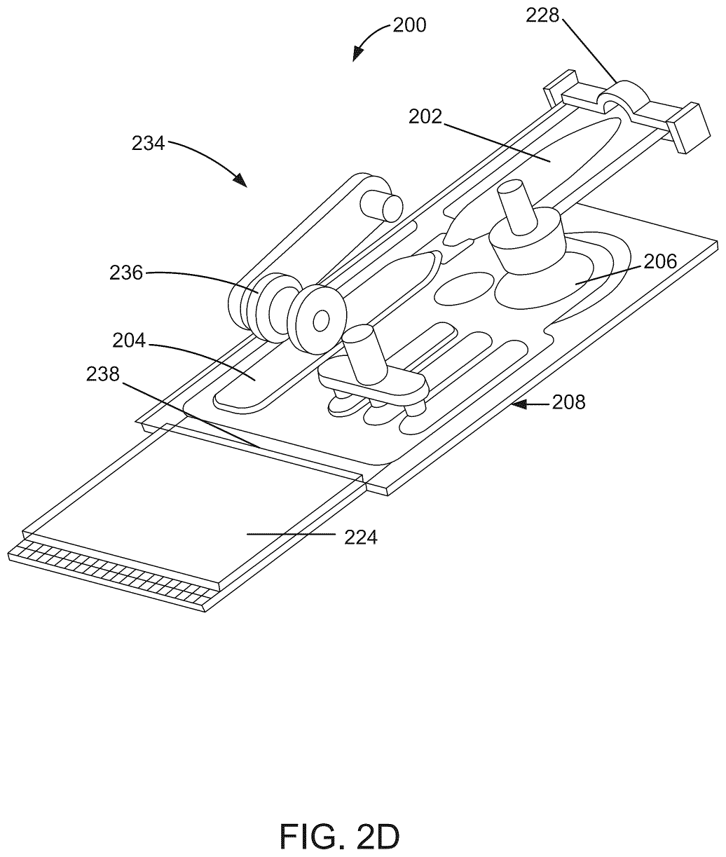

Referring now to the figures, FIG. 1 is a simplified block diagram of an example computing device 100 of a system (e.g., that can be utilized with devices and methods illustrated in FIGS. 2A-4, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor and/or a central processing unit (CPU)) and/or a special-purpose processor (e.g., a digital signal processor (DSP) and/or a graphics processing unit (GPU)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIGS. 2A-2E, an example device 200 for preparing a biological sample, e.g. a fecal sample. In example embodiments, the device 200 includes a receiving chamber 202 for receiving a biological sample (e.g., a fecal sample). Once the biological sample is deposited into the receiving chamber 202, the biological sample is moved through a number of different chambers of the device, including a buffer chamber 204, a filter chamber 206, and a reagent reservoir 208, all of which prepare the biological sample for testing with limited user interaction. Namely, the biological sample is moved through the series of chambers via fluidic communication mechanisms between each of the chambers. Actuating the fluidic communication mechanisms between the chambers provides a fluidic communication between the respective chambers. The device 200 includes multiple layers, such that certain chambers are on different planes from one another. As such, the device utilizes fluidic communication across multiple planes to take advantage of gravity and other forces during actuation.

Referring specifically to FIGS. 2A-2B, the device 200 includes a receiving chamber 202. The receiving chamber 202 includes an opening allowing a user to deposit the biological sample into the receiving chamber 202. In some examples, the receiving chamber 202 includes a seal (shown in FIGS. 2C and 2D) to seal the receiving chamber 202 once the biological sample has been deposited. The seal prevents volume loss of the biological sample and limits user interaction with the sample.

In example embodiments, the receiving chamber 202 includes compliant material, such as Linear Low Density Polyethylene (LLDPE) and/or Low Density Polyethylene (LDPE). In some examples, the receiving chamber 202 can additionally or alternatively include more sustainable and/or environmentally friendly materials, such as foil and/or natural fibers. Other example materials are possible.

After the biological sample is deposited into the receiving chamber 202, the biological sample can be transferred to the buffer chamber 204 via a fluidic communication mechanism 214. As noted above, in example embodiments the receiving chamber 202 includes compliant material. Application of a force and/or compression of the receiving chamber 202 can actuate the fluidic communication mechanism 214. Actuation of the fluidic communication mechanism 214 provides a fluidic communication between the receiving chamber 202 and the buffer chamber 204, allowing the biological sample to be transferred to the buffer chamber 204, for example, by fluidic forces.

In example embodiments, the fluidic communication mechanism 214 can include a metering seal to remove excess biological sample as it is deposited into the receiving chamber 202 and prevent excess biological sample from being transferred to the buffer chamber 204. Additionally, a metering seal helps keep the fluid buffer sealed, as oxygen can deteriorate the fluid buffer. The metering seal can also prevent backflow and/or volume loss of the biological sample. Additionally or alternatively, the fluidic communication mechanism 214 can include a pierceable cover, e.g. a pierceable foil or film. In these examples, actuating the fluidic communication mechanism 214 includes piercing and/or rupturing the pierceable cover. Additionally or alternatively, the fluidic communication mechanism 214 can include a valve. In these examples, actuating the fluidic communication mechanism 214 includes opening the valve. Other example fluidic communication mechanisms are possible.

In some examples, a user may insert the biological sample into the receiving chamber 202 via an applicator (shown in FIGS. 2C and 2D). In these examples, the applicator may actuate the fluidic communication mechanism 214. For instance, in examples where the fluidic communication mechanism 214 includes a pierceable cover, the user may puncture the pierceable cover with the applicator when depositing the biological sample into the receiving chamber 202.

Once the biological sample is transferred to the buffer chamber 204, the biological sample can mix with the fluid buffer. The buffer chamber 204 includes an on-board fluid buffer, for example, to prevent pH fluctuations in the biological sample. Example fluid buffers can include, but are not limited to, Phosphate-buffered saline (PBS), Tris-buffered saline (TBS), Hanks' Balance Salt Solution (HBSS), and/or glycerol-based cryopreservation buffer.

In example embodiments, the buffer chamber 204 includes compliant material, such as LLDPE, LDPE, or foil. In some examples, the buffer chamber 204 can additionally or alternatively include more sustainable and/or environmentally friendly materials, such as foil and/or natural fibers. Other example materials are possible. As such, while the biological sample is in the buffer chamber 204, a user and/or actuator (shown in FIGS. 2C and 2D) can apply a force and/or compress the buffer chamber 204 to further mix the biological sample with the fluid buffer.

After the biological sample is mixed with the fluid buffer in the buffer chamber 204, the biological sample can be transferred to the filter chamber 206 via a fluidic communication mechanism 216. In example embodiments where the buffer chamber 204 includes compliant material, application of force and/or compression of the buffer chamber 204 can actuate the fluidic communication mechanism 216. Actuation of the fluidic communication mechanism 216 provides a fluidic communication between the buffer chamber 204 and the filter chamber 206, allowing the biological sample to be transferred to the filter chamber 206, for example, by fluidic forces.

In example embodiments, the fluidic communication mechanism 216 can include a pierceable cover. In these examples, actuating the fluidic communication mechanism 216 includes piercing and/or rupturing the pierceable cover. Additionally or alternatively, the fluidic communication mechanism 216 can include a valve. In these examples, actuating the fluidic communication mechanism 216 includes opening the valve. Other example fluidic communication mechanisms are possible.

In some examples, the second fluidic communication mechanism 216 includes and/or is in fluidic communication with a channel 218. The channel 218 allows the biological sample to flow from the buffer chamber 204 to the filter chamber 206. In some examples, when the device 200 lies flat or substantially flat, the filter chamber 206 is below (e.g., on a lower plane than) the buffer chamber 204 which allows the biological sample to be gravity-fed into the filter chamber 206 (e.g., a level change, as shown in FIG. 2B) via the channel 218. Additionally or alternatively, the channel 218 may include or be in fluidic communication with a filter 240 (e.g., a course filter).

Once the biological sample is transferred to the filter chamber 206, the biological sample can be filtered through a porous membrane 220. In example implementations, the biological sample flows through the porous membrane 220 via gravitational forces. As such, the biological sample goes through a level change when passing through the porous membrane 220, as shown in FIG. 2B. In some examples, the porous membrane 220 is a fine filter.

As noted above, a common issue with certain types of samples (e.g., fecal samples) is the variation in consistency between samples. For example, one sample be a more dehydrated sample such that it is a more solid sample. The porous membrane 220 helps clarifies the biological sample to create a more desirable consistency for testing.

In example embodiments, the filter chamber 206 includes compliant material, such as LLDPE, LDPE, or foil. In some examples, the filter chamber 206 can additionally or alternatively include more sustainable and/or environmentally friendly materials, such as foil and/or natural fibers. Other example materials are possible. As such, application of a force and/or compression of the filter chamber 206 can help force the biological sample through porous membrane 220. Additionally, application of a force or compression of the filter chamber 206 can help transport the biological sample to the reagent reservoir 208 by way of fluidic communication mechanism 222.

In some examples, fluidic communication mechanism 222 includes a channel. Additionally or alternatively, the fluidic communication mechanism 222 can include a pierceable cover and/or a valve. In these examples, application of a force and/or compression of the 220 of the filter chamber 206 can actuate the fluidic communication mechanism 222 to provide a fluidic communication between the filter chamber 206 and the reagent reservoir 208.

In example embodiments, the reagent reservoir 208 includes one or more chambers 210A, 210B, and 210C. Each of these one or more chambers 210A, 210B, and 210C includes a respective fluidic communication mechanism 212A, 212B, and 212C. Before these fluidic communication mechanisms 212A, 212B, and 212C are actuated, they retain the fluids in each respective chamber. Namely, the chambers 210A, 210B, and 210C are not in fluidic communication with one another before the fluidic communication mechanisms 212A, 212B, and 212C are actuated.

In example implementations, chamber 210A is in fluidic communication with the filter chamber 206 via the fluidic communication mechanism 222. Accordingly, chamber 210A receives the clarified biological sample after it has passed through the porous membrane 220 and the fluidic communication mechanism 222. Chamber 210B and chamber 210C can include one or more on-board reagents to prepare the biological sample for testing. In examples, the reagents can include one or more of: (i) a binding reagent; (ii) a wash reagent; (iii) a conjugate reagent; (iv) a fluorescent stain; (v) markers; or (vi) transport (e.g., oil). In examples, chamber 210B can include a binding reagent and chamber 210C can include a wash reagent, or vice versa. Many example combinations of reagents are possible.

In example embodiments, the reagent reservoir 208 includes compliant material, such as LLDPE and/or LDPE. In some examples, the reagent reservoir 208 can additionally or alternatively include more sustainable and/or environmentally friendly materials, such as foil and/or natural fibers. Other example materials are possible. Application of a force and/or compression of the chambers 210A, 210B, and 210C of the reagent reservoir 208 can actuate the fluidic communication mechanisms 212A, 212B, and 212C by fluidic forces.

Actuating the fluidic communication mechanisms 212A, 212B, and 212C provides a fluidic communication between the chambers 210A, 210B, and 210C and the outlet 238 so that the biological sample and on-board reagents can mix with one another. In example embodiments, the fluidic communication mechanisms 212A, 212B, and 212C can include a pierceable cover. In these examples, actuating the fluidic communication mechanisms 212A, 212B, and 212C includes piercing and/or rupturing the pierceable cover. Additionally or alternatively, the fluidic communication mechanisms 212A, 212B, and 212C can include a valve. In these examples, actuating the fluidic communication mechanism 212A, 212B, and 212C includes opening the valve. Other example fluidic communication mechanisms are possible.

In examples, actuation of the fluidic communication mechanisms 212A, 212B, and 212C can be done simultaneously. Alternatively, in some examples, actuation of the fluidic communication mechanisms 212A, 212B, and 212C can be done sequentially. For instance, fluidic communication mechanism 212A can be actuated first, fluidic communication mechanism 212B can be actuated second, and 212C can be actuated third.

Once the fluidic communication mechanisms 212A, 212B, and 212C are actuated, the fluidic forces transfer the biological sample and the on-board reagents through to the outlet 238 allowing the biological sample to mix with the on-board reagents. Once the biological sample has mixed with the on-board reagents, the biological sample is prepared for testing.

In example implementations, the outlet 238 is configured to be coupled with a cartridge 224 suitable for imaging. In this manner, the device 200 can be integrated with an imaging machine to perform testing on the biological sample. For instance, the device 200 can prepare the biological sample for a number of different imaging protocols (e.g., a microfluidic assay, a lateral flow assay, an EWOD assay, an assay using bar-coded magnetic beads, an immunoassay, a PCR assay etc.) Integration of the cartridge 224 with the outlet 238 further reduces and/or prevents user interaction with the biological sample.

Now referring to FIG. 2C which illustrates the example device 200, further including an applicator 226, a seal 228, and an actuator 230. In some examples, a user may insert the biological sample into the receiving chamber 202 via an applicator 226. In these examples, the applicator 226 may open the seal 228 to allow the applicator 226 to enter the receiving chamber 202 and/or actuate the fluidic communication mechanism 214, among other possibilities. For instance, in examples where the fluidic communication mechanism 214 includes a pierceable cover, the user may puncture the pierceable cover with the applicator when depositing the biological sample into the receiving chamber 202.

Removal of the biological sample from the applicator 226 can be challenging because the biological sample may stick to the applicator 226. As such, in some examples, the receiving chamber 202 can include features to help remove the biological sample, such as one or more scrubbers or ribs. Additionally or alternatively, the receiving chamber 202 is made of a compliant material so that the user can compress (e.g., pinch or squeeze) the receiving chamber while the applicator 226 is inserted to help remove the biological sample.

In example embodiments, the device can include a seal 228 adjacent to an opening of the receiving chamber 202. In these examples, the seal 228 can receive the applicator 226. Once the biological sample is deposited into the receiving chamber 202, the user can close the seal 228 to prevent loss of the biological sample. The seal 228 can also reduce a user's exposure to the biological sample.

In some example embodiments, the device 200 can further include an actuator 230, such as a manual actuator. The actuator 230 is configured to move along the length of the device 200 and includes a slide 232 configured to move side-to-side along the length of the actuator 230. The slide 232 is configured to compress each chamber to actuate the respective fluidic communication mechanisms and move the biological sample through each chamber. The slide 232 allows for the sequential actuation of each chamber without removing the actuator 230 from the device 200.

For instance, once the biological sample is deposited into the receiving chamber 202, the slide 232 of the actuator 230 can be positioned to compress the receiving chamber 202 (as shown in FIG. 2C), thereby actuating fluidic communication mechanism 214 and moving the biological sample to the buffer chamber 204. In some examples, once the biological sample is in the buffer chamber 204, the slide 232 can be moved in a repeated and/or reciprocating manner to help further mix the biological sample with the buffer. The slide 232 can be positioned to compress the buffer chamber 204, thereby actuating fluidic communication mechanism 216 and moving the biological sample to the filter chamber 206. Once the biological sample is in the filter chamber 206, the slide 232 can be positioned to compress the filter chamber 206, thereby forcing the biological sample through the porous membrane 220, actuating fluidic communication mechanism 222, and moving the biological sample to chamber 210A of the reagent reservoir 208. Once the biological sample is in the reagent reservoir 208, the slide 232 can be positioned to compress chambers 210A, 210B, and 210C, thereby actuating fluidic communication mechanisms 212A, 212B, and 212C, and moving the biological sample and on-board reagents to the outlet 238.

In some example implementations, the device 200 can include notches (not shown) on the sides of the device to assist a user with placement of the actuator 230. For instance, the device 200 can include a notch on either side of the device 200 where the actuator 230 should be positioned to compress the receiving chamber 202. The device 200 can include a notch on either side of the device 200 where the actuator 230 should be positioned to compress the buffer chamber 204. The device 200 can include a notch on either side of the device 200 where the actuator 230 should be positioned to compress the filter chamber. And, the device 200 can include a notch on either side of the device 200 where the actuator 230 should be positioned to compress the reagent reservoir 208.

Now referring to FIG. 2D which illustrates the example device 200, including an automated actuator 234. The automated actuator 234 is configured to compress each chamber in sequence to actuate the respective fluidic communication mechanisms and move the biological sample through each chamber. For instance, in examples, the automated actuator 234 can include and/or be communicably coupled to a computing device, such as computing device 100. The computing device 100 can include instructions that, when executed by a processor, cause the automated actuator 234 to compress the various chambers at predetermined times, causing the respective fluidic communication mechanisms to actuate sequentially.

For instance, once the biological sample is deposited into the receiving chamber 202, the automated actuator 234 can apply a force to the receiving chamber 202, thereby actuating fluidic communication mechanism 214 and moving the biological sample to the buffer chamber 204.

In some examples, the automated actuator 234 can include a roller 236 configured to roll along the buffer chamber 204, lightly compressing the buffer chamber 204 (e.g., apply a force that is not great enough to actuate fluidic communication mechanism 216) to mix the biological sample with the fluid buffer. Additionally or alternatively, the actuator 234 can apply a force to the buffer chamber 204 in a repeated and/or reciprocal manner to mix the biological sample with the fluid buffer. Once the biological sample is in the buffer chamber 204 and mixed with the fluid buffer, the automated actuator 234 can apply a force to the buffer chamber 204, thereby actuating fluidic communication mechanism 216 and moving the biological sample to the filter chamber 206.

Once the biological sample is in the filter chamber 206, the automated actuator 234 can apply a force to the filter chamber 206, thereby forcing the biological sample through the porous membrane 220, actuating fluidic communication mechanism 222, and moving the biological sample to chamber 210A of the reagent reservoir 208.

Once the biological sample is in the reagent reservoir 208, the automated actuator 234 can apply a force to chambers 210A, 210B, and 210C, thereby actuating fluidic communication mechanisms 212A, 212B, and 212C, and moving the biological sample and on-board reagents to the outlet 238.

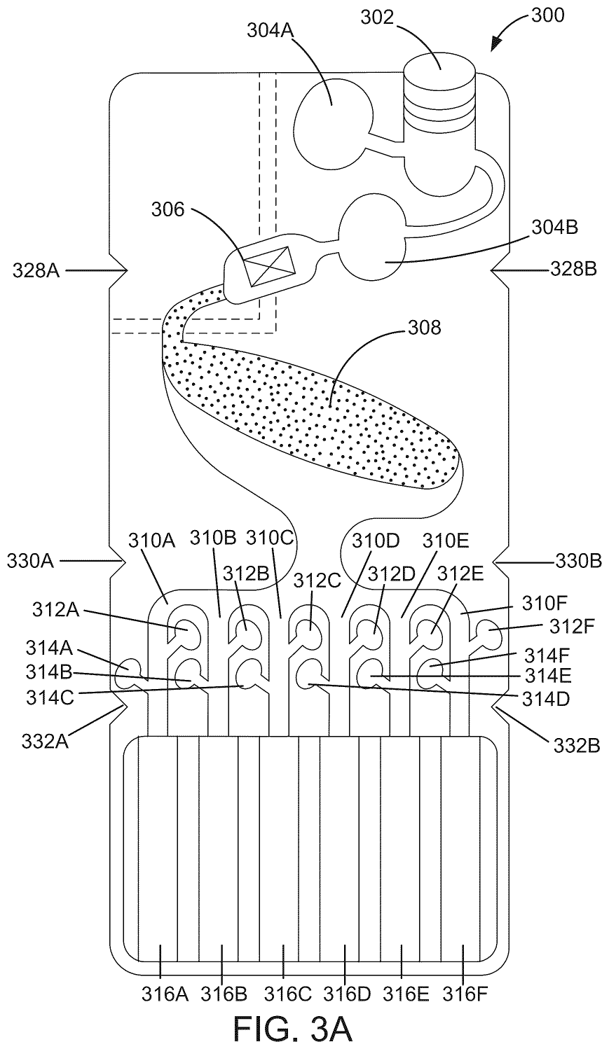

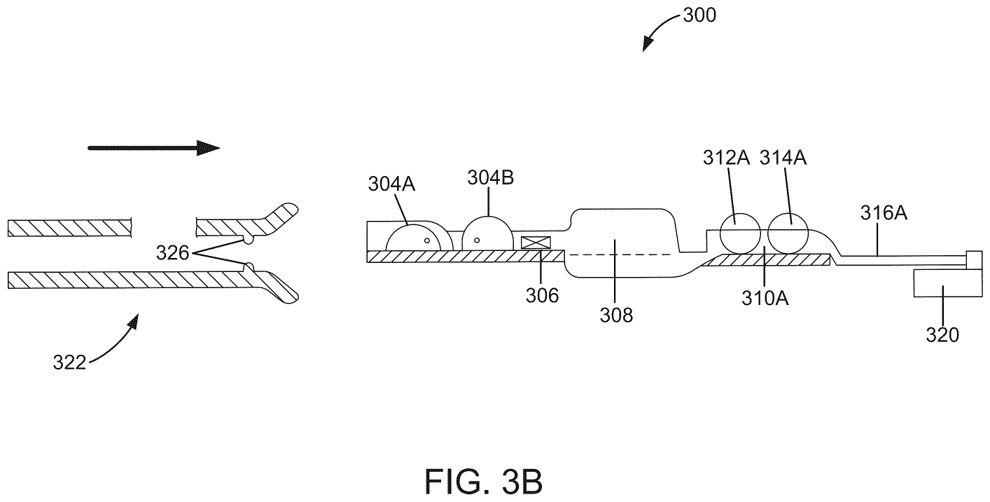

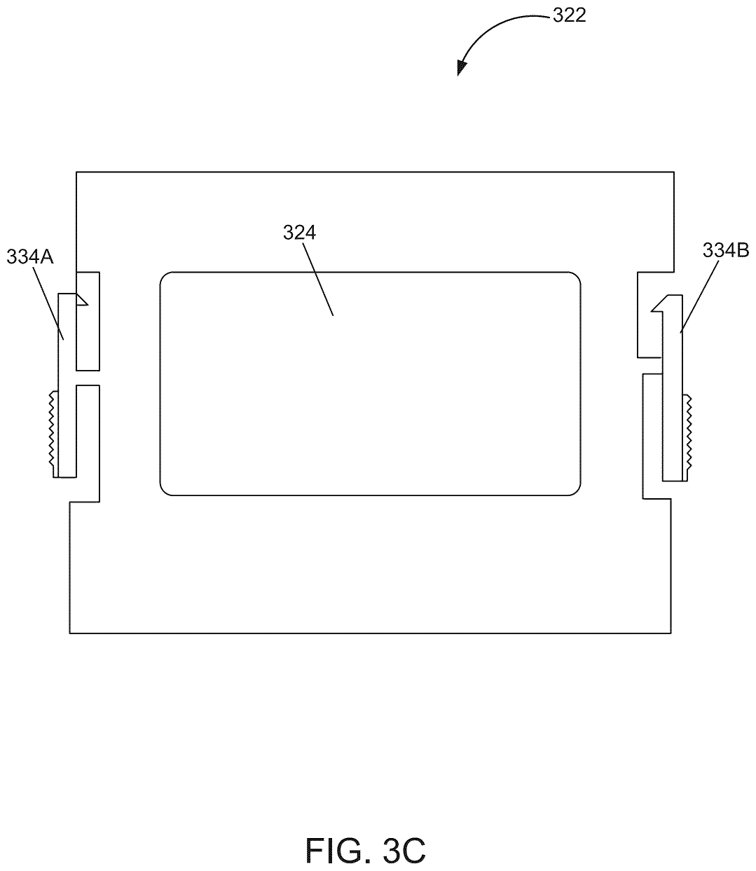

Now referring to FIGS. 3A-3C, an example device 300 for preparing a biological sample for testing and, in some examples, performing one or more tests on the biological sample. More particularly, FIG. 3A shows a front view of the device 300 and FIG. 3B shows a cross-sectional view of the device 300 and an actuator 322. Once the biological sample is deposited into the receiving chamber 302, the biological sample is moved through a number of different chambers of the devices, including one or more buffer chambers 304A and 304B, a filter 308, one or more reagent channels 310A-310F, and one or more test strips 316A-316F, to prepare and test the biological sample with limited user interaction. Compression of each chamber moves the biological sample through each chamber via fluidic forces, such that the prepared biological sample is delivered to the one or more test strips 316A-316F. The one or more test strips 316A-316F support directional flow of the biological sample to an absorbent pad 320. The one or more test strips 316A-316F perform one or more tests on the biological sample based on the directional flow of the biological sample.

As noted above, the device 300 includes a receiving chamber 302. The receiving chamber 302 includes an opening allowing a user to deposit the biological sample into the receiving chamber 302. In some examples, the receiving chamber 302 includes a seal (not shown) to seal the receiving chamber 302 once the biological sample has been deposited. The seal prevents volume loss of the biological sample and limits user interaction with the sample.

The receiving chamber 302 is in fluidic communication with one or more buffer chambers 304A and 304B. The buffer chambers 304A and 304B can include an on-board fluid buffer, for example, to prevent pH fluctuations in the biological sample. Example fluid buffers can include, but are not limited to PBS, TBS, HBSS, and/or glycerol-based cryopreservation buffer.

The buffer chambers can include compliant material (e.g., LLDPE, LDPE, or foil) such that application of a force and/or compression of the buffer chambers 304A and 304B moves the fluid buffer between the buffer chambers and the receiving chamber 302. As such, a user and/or actuator 322 can mix the biological sample with the fluid buffer. In examples, buffer chambers 304A and 304B can be compressed in an oscillating and/or alternating manner to help emulsify solid phase biological sample and mix the biological sample with the buffer fluid.

After the biological sample is emulsified and mixed with the fluid buffer, the biological sample can be moved (e.g., via fluidic forces) to the filter 308. In example embodiments, the device 300 can include a fluidic communication mechanism 306, such as a crush valve, to provide a fluidic communication between the buffer chamber 304B and a filter 308, such as a porous membrane. The fluidic communication mechanism 306 can be actuated (e.g., the crush valve can be opened) by applying a force and/or compressing buffer chamber 304B (e.g., a seal can crack and/or rupture at a certain pressure).

In example implementations, the biological sample flows through the filter 308 via gravitational forces. In other examples, the biological sample can be moved through the filter 308 via fluidic forces from compression of the filter 308. As noted above, a common issue with certain types of samples (e.g., fecal samples) is the variation in consistency between samples. For example, one sample be a more dehydrated sample such that it is a more solid sample. The filter 308 helps clarifies the biological sample to create a more desirable consistency for testing.

In example implementations, filter 308 is in fluidic communication with reagent channels 310A-310F. Accordingly, reagent channels 310A-310F receive the clarified biological sample after it has passed through the filter 308.

Each reagent channel 310A-310F can include sealed reagent packs which include a fluid reagent. Namely, each reagent channel 310A-310F can include a respective first reagent pack 312A-312F and a respective second reagent pack 314A-314F. For purposes of clarity, only reagent packs 312A and 312F are labeled, however each channel 310A-310F can include a first reagent pack as shown in FIG. 3A. Reagent packs 312A-312F and reagent packs 314A-314F can include one or more on-board reagents to prepare the biological sample for testing. In examples, the reagents can include one or more of: (i) a binding reagent; (ii) a wash reagent; (iii) a conjugate reagent; (iv) a fluorescent stain; (v) markers; or (vi) transport (e.g., oil). In examples, first reagent packs 312A-312F can include a binding reagent and second reagent pack 314A-314F can include a wash reagent. In other examples first reagent packs 312A-312F can include a wash reagent and second reagent pack 314A-314F can include a binding reagent, or both can include the similar reagents, among other possibilities. Many example combinations of reagents are possible.

In example embodiments, the reagent channels 310A-310F include compliant materials, such that application of a force and/or compression of the reagent channel 310A-310F moves the biological sample towards the test strips 316A-316F. Similarly, the reagent packs 312A-312F and reagent packs 314A-314F includes compliant material, such as LLDPE, LDPE, or foil. Application of a force and/or compression of reagent packs 312A-312F and reagent packs 314A-314F can release fluid from the reagent packs, allowing the on-board reagents into the respective reagent channels 310A-310F to mix with the biological sample.

In some example embodiments, the device 300 can further include an actuator 322. The actuator 322 is configured to move along the length of the device 300 and can include compression nubs 326. The compression nubs 326 are configured to compress each chamber to move the biological sample through each chamber of the device 300.

For instance, once the biological sample is deposited into the receiving chamber 302, the compression nubs 326 can be positioned to compress the buffer chamber 304, thereby mixing the fluid buffer with the biological sample and moving the biological sample to the fluidic communication mechanism 306. The compression nubs 326 can actuate the fluidic communication mechanism 306, or the user can actuate the communication mechanism by folding the corner of the card and force the biological sample through to the filter 308. The compression nubs 326 can then be positioned to compress the receiving chamber 302 to filter 308, thereby forcing the biological sample through the filter 308 to the reagent channels 310A-310F. Once the biological sample is in the reagent channels 310A-310F, the compression nubs 326 can be positioned to compress and release the first reagent packs 312A-312F into the reagent channels 310A-310F. The compression nubs 326 can then be positioned to compress and release the second reagent packs 314A-314F into the reagent channels 310A-310F. The compression nubs 326 can then compress the remainder of the reagent channels 310A-310F, moving the biological sample and on-board reagents to the test strips 316A-316F.

In some examples, the device 300 can include one or more set of notches (e.g., notches 328A and 328B, notches 330A and 330B, and notches 332A and 332B) on the sides of the device 300. These notches can assist a user with placement of the actuator 322 at various stages of preparing the biological sample. In example implementations, these notches are compatible with clips 334A and 334B (shown in FIG. 3C). The notches and clips can help hold the actuator 322 in place, for example, during any time dependent steps.

Additionally or alternatively, in some examples, device 300 can include an automated actuator, similar to automated actuator 234. The automated actuator is configured to compress each chamber in sequence to actuate the respective fluidic communication mechanisms and move the biological sample through each chamber. For instance, in examples, the automated actuator can include and/or be communicably coupled to a computing device, such as computing device 100. The computing device 100 can include instructions that, when executed by a processor, cause the automated actuator to compress the various chambers at predetermined times, causing the respective fluidic communication mechanisms to actuate sequentially

Once the biological sample has mixed with the on-board reagents and the biological sample is moved to the test strips 316A-316F, the biological sample is prepared for testing. Namely, the biological sample and fluid reagents are delivered from the reagent channels 310A-310F across the one or more test strips 316A-316F to the absorbent pad 320 by capillary force. In example embodiments, the directional flow of the fluid reagent is a lateral unidirectional flow.

The unidirectional flow of the biological sample and reagents across the one or more test strips 316A-316F allows the one or more test strips 316A-316F to perform one or more tests on the biological sample. In some example implementations, performing a test involves detecting the presence of one or more analytes in the biological sample. To do so, in some examples, the test strip comprises at least one of the following: (i) antibodies; (ii) antigens; (iii) aptamers; (iv) or peptides.

In some example embodiments, each of the one or more test strips 316A-316F is configured to perform a different test for analytes that can be detected in biological samples as a result of a binding assay, typically an immunoassay. Example tests can include the determination of a vast variety of analytes know in the art to be detectable by, for example, immunoassay, including, but are not limited to: (i) Anaplasma, (ii) Ehrlichia, (iii) heartworm, (iv) Lyme disease, (v) Feline Immunodeficiency Virus (FIV), (vi) Feline leukemia virus (FeLV), (vii) Giardia, (viii) Parvo, (ix) Lepto, (x) hookworm, (xi) roundworm, (xii) whipworm, (xiii) tapeworm, (xiv) cystoisospora, (xv) Campylobacter jejuni, (xvi) Cryptosporidium, (xvii) enteric coronavirus, (xviii) Salmonella, or (xix) tritrichromonas. In an example implementation, a first test strip 316A is configured to perform a Anaplasma test, a second test strip 316B is configured to perform a Ehrlichia test, a third test strip 316C is configured to perform a heartworm test, etc. In another example configuration, one or more of the test strips 316A-316F are configured to perform the same test for redundancy. Many example combinations of tests are possible.

In some example implementations, test strips of different dimensions and porosities can be utilized to control the speed and/or time of the directional flow based on the type of test and/or the type of sample.

In example implementations, the one or more test strips 316A-316F are configured to provide a visual indication of a testing result based on the directional flow of the sample and the reagent. For instance, a line can appear on the test strip 316A indicating a positive result or a negative result of a particular test. In another example, the test strip 316A may turn a certain color to indicate a positive result or negative testing result of a particular test depending on the label associated with fluid reagent(s)

In example embodiments, the actuator 322 can include an optically transparent viewing window 324 suitable for viewing and/or imaging. Namely, when the actuator 322 has been moved across the device 300, the viewing window 324 is above at least a portion of the one or more test strips 316A-316F. This allows for a user to view the visual indication of the testing result. The optically transparent viewing window 324 additionally or alternatively allows for imaging (either visually or with an optical reader) of at least a portion of the one or more test strips 316A-316F.

In examples, each chamber of the device 300 can be actuated manually by a user (i.e., by hand). Additionally or alternatively, the device 300 can include a manual actuator, similar to actuator 230 shown in FIG. 2C. Additionally or alternatively, the device can include an automated actuator, similar to actuator 234 shown in FIG. 2D.

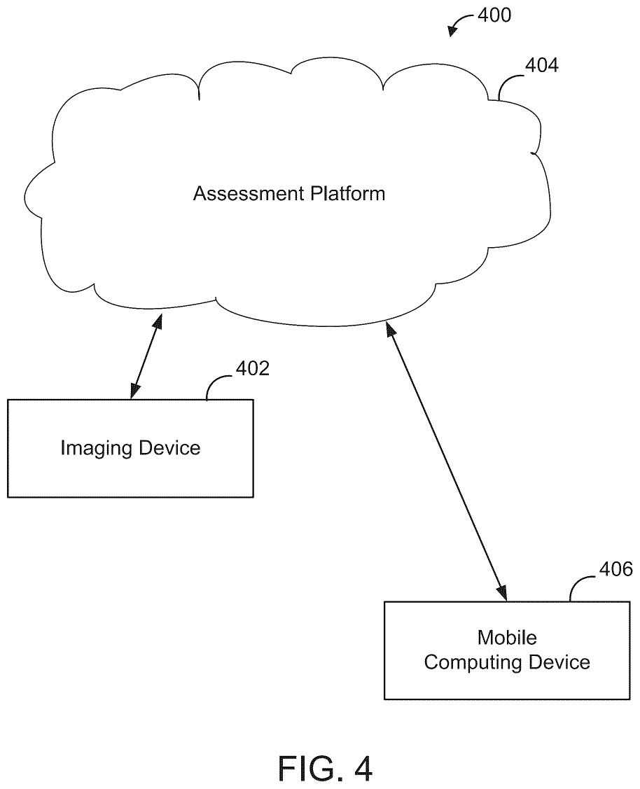

Now referring to FIG. 4, a computing system 400 configured for use with an imaging device 402 and a mobile computing device 406, according to an example embodiment. Example devices (e.g., 200 and 300) are compatible with an imaging device 402 that can read an optical signal present on a cartridge and/or a test strip. Signals may include a color or intensity of light associated with the test strip or may detect an image present on the strip that is associated with a bead (e.g., barcoded, shape, size, etc) present on the strip. An imaging device 402 includes a computing device, such as computing device 100. It should also be readily understood that computing device 100 and the imaging device 402, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 400 can include various components, such as the computing device 100, imaging device 402, a cloud-based assessment platform.

The imaging device 402 and/or components thereof can perform various acts and/or functions (many of which are described above). Examples of these and related features will now be described in further detail.

The imaging device 402 may collect data from a number of sources. In one example, the imaging device 402 may collect data from a database of images related to testing of samples, including one or more images of the biological sample, cartridges, and/or test strips. The images may be uploaded to an assessment platform 404 and characteristics of the images may be output to a mobile computing device 406.

In an example, assessment platform 404 may collect data from one or more sensors communicably coupled to the imaging device 402, such as an imaging sensor, concerning a particular sample. In such examples, the assessment platform 404 may identify a characteristic of the sample or a testing result and transmit instructions to the mobile computing device 406 to cause a graphical user interface to display a graphical indication of the identified characteristic and/or testing result. In some examples, the assessment platform 404 may determine a testing result by utilizing one or more of: (i) an artificial neural network, (ii) a support vector machine, (iii) a regression tree, or (iv) an ensemble of regression trees.

In another example, the imaging device 402 may collect data from one or more sensors communicably coupled to the imaging device, such as an imaging sensor, concerning a particular sample and/or test strip. In some examples, the assessment platform 404 may determine a characteristic of the sample and/or testing result by utilizing one or more of: (i) an artificial neural network, (ii) a support vector machine, (iii) a regression tree, or (iv) an ensemble of regression trees.

In some examples, images that are captured by the imaging device can be stored within a memory, such as a memory of computing device 100, to be subsequently analyzed.

In one example, the imaging device 402 may train a machine learning model using data associated images of biological samples, cartridges, and/or test strips that share a characteristic with captured images of biological samples, cartridges, and/or test strips. The machine learning model may be trained using training data that shares a characteristic and/or testing result with biological samples, cartridges, and/or test strips to be analyzed by the imaging device. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

In some examples, the machine learning model of the imaging device 402 may be adjusted based on training such that if the outcome of a determined testing result matches the characteristic and/or testing result of the training images, the machine learning model is reinforced and if the outcome of a determined testing result does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Once the imaging device 402 has determined a characteristic of a sample in one or more images, the imaging device may transmit instructions that cause a computing device (e.g., the computing device 100) to display one or more graphical indications of the identified characteristic and/or the enhanced image.

In some example embodiments, the biological testing sample can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, Cl, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

### EXAMPLE METHODS AND ASPECTS

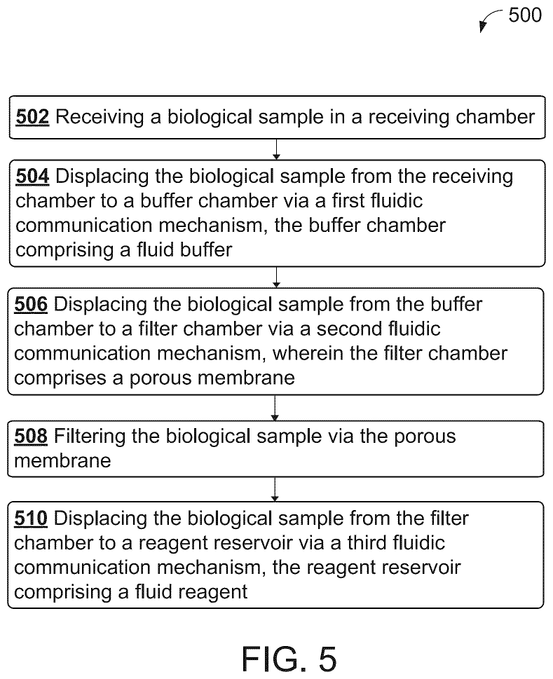

Now referring to FIG. 5, an example method of preparing a biological testing sample is disclosed. Method 500 shown in FIG. 5 presents an example of a method for preparing a biological testing sample that could be used with the components shown in FIGS. 2A-3C, for example. Further, devices or systems may be used or configured to perform logical functions presented in FIG. 5. In other examples, components of the devices and/or systems may be arranged to be adapted to, capable of, or suited for performing the functions, such as when operated in a specific manner. Method 500 may include one or more operations, functions, or actions as illustrated by one or more of blocks 502-510. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 502, method 500 involves receiving a biological sample in a receiving chamber.

At block 504, method 500 involves displacing the biological sample from the receiving chamber to a buffer chamber via a first fluidic communication mechanism, the buffer chamber comprising a fluid buffer. In some examples, displacing the biological sample from the receiving chamber to the buffer chamber comprises actuating the first fluidic communication mechanism to provide a fluidic communication between the receiving chamber and the buffer chamber

At block 506, method 500 involves displacing the biological sample from the buffer chamber to a filter chamber via a second fluidic communication mechanism, wherein the filter chamber comprises a porous membrane. In some examples, displacing the biological sample from the buffer chamber to the filter chamber comprises actuating the second fluidic communication mechanism to provide a fluidic communication between the buffer chamber and the filter chamber.

At block 508, method 500 involves filtering the biological sample via the porous membrane.

At block 510, method 500 involves, displacing the biological sample from the filter chamber to a reagent reservoir via a third fluidic communication mechanism, the reagent reservoir comprising a fluid reagent. In some examples, displacing the biological sample from the filter chamber to the reagent reservoir comprises actuating the third fluidic communication mechanism to provide a fluidic communication between the filter chamber and the reagent reservoir.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A device for preparing a biological sample, wherein the device comprises:
a receiving chamber;
a buffer chamber, wherein the buffer chamber comprises a fluid buffer and a first fluidic communication mechanism between the receiving chamber and the buffer chamber;
a filter chamber, wherein the filter chamber comprises a porous membrane, and wherein the buffer chamber comprises a second fluidic communication mechanism between the buffer chamber and the filter chamber; and
a reagent reservoir, wherein the reagent reservoir comprises a fluid reagent and a third fluidic communication mechanism between the filter chamber and the reagent reservoir.

2. The device of claim 1, wherein the first fluidic communication mechanism provides a fluidic communication between the receiving chamber and the buffer chamber.

3. The device of claim 1, wherein the second fluidic communication mechanism provides a fluidic communication between the buffer chamber and the filter chamber.

4. The device of claim 1, wherein the third fluidic communication mechanism provides a fluidic communication between the filter chamber and the reagent reservoir.

5. The device of claim 1, wherein at least one of the first fluidic communication mechanism, the second fluidic communication mechanism, and the third fluidic communication mechanism include a pierceable cover.

6. The device of claim 5, wherein the first fluidic communication mechanism provides a fluidic communication between the receiving chamber and the buffer chamber when the pierceable cover is ruptured.

7. The device of claim 5, wherein the second fluidic communication mechanism provides a fluidic communication between the buffer chamber and the filter chamber when the pierceable cover is ruptured.

8. The device of claim 1, wherein the receiving chamber comprises a compliant material, and wherein compression of the receiving chamber actuates the first fluidic communication mechanism and transfers at least a portion of a biological sample from the receiving chamber to the buffer chamber.

9. The device of claim 1, wherein the buffer chamber comprises a compliant material, and wherein compression of the buffer chamber actuates the second fluidic communication mechanism and transfers at least a portion of a biological sample from the buffer chamber to the buffer chamber.

10. The device of claim 1, wherein the filter chamber comprises a compliant material, and wherein compression of the reagent reservoir: (i) provides a fluidic communication between the receiving chamber via the third fluidic communication mechanism, (ii) and transfers at least a portion of the biological sample from the filter chamber to the reagent reservoir.

11. The device of claim 1, wherein the reagent reservoir comprises a plurality of chambers.

12. The device of claim 11, further comprising:
an outlet, wherein the outlet is in fluidic communication with one or more chambers of the plurality of chambers.

13. The device of claim 12, wherein the plurality of chambers comprises: (i) a first chamber configured to receive a biological sample from the filter chamber via the third fluidic communication mechanism and a fourth fluidic communication mechanism which, once actuated, provides fluidic communication between the first chamber and the outlet, and (ii) a second chamber comprising the fluid reagent, wherein the second chamber comprises a fifth fluidic communication mechanism which, once actuated, provides fluidic communication between the second chamber and the outlet.

14. The device of claim 13, wherein a biological sample and the fluid reagent are mixed in the outlet.

15. The device of claim 12, wherein the outlet comprises at least a portion of a cartridge.

16. The device of claim 1, further comprising:
an actuator configured to: (i) displace at least a portion of the biological sample from the receiving chamber to the buffer chamber via the first fluidic communication mechanism, (ii) displace at least a portion of the biological sample from the buffer chamber to the filter chamber via the second fluidic communication mechanism, and (iii) displace at least a portion of the biological sample from the filter chamber to the reagent reservoir via the third fluidic communication mechanism.

17. The device of claim 16, wherein the actuator is communicably coupled to a computing device.

18. A method of preparing a biological sample for testing, the method comprising:
receiving a biological sample in a receiving chamber;
displacing the biological sample from the receiving chamber to a buffer chamber via a first fluidic communication mechanism, the buffer chamber comprising a fluid buffer;
displacing the biological sample from the buffer chamber to a filter chamber via a second fluidic communication mechanism, wherein the filter chamber comprises a porous membrane;
filtering the biological sample via the porous membrane; and
displacing the biological sample from the filter chamber to a reagent reservoir via a third fluidic communication mechanism, the reagent reservoir comprising a fluid reagent.

19. The method of claim 18, wherein:
displacing the biological sample from the receiving chamber to the buffer chamber comprises actuating the first fluidic communication mechanism to provide a fluidic communication between the receiving chamber and the buffer chamber;
displacing the biological sample from the buffer chamber to the filter chamber comprises actuating the second fluidic communication mechanism to provide a fluidic communication between the buffer chamber and the filter chamber; and
displacing the biological sample from the filter chamber to the reagent reservoir comprises actuating the third fluidic communication mechanism to provide a fluidic communication between the filter chamber and the reagent reservoir.

20. A device for testing a biological sample, the device comprising:
a receiving chamber;
a buffer chamber, wherein the buffer chamber comprises a fluid buffer and is in fluidic communication with the receiving chamber;
a filter configured to filter the biological sample, wherein the buffer chamber comprises a first fluidic communication mechanism between the buffer chamber and the filter;
a reagent channel, wherein the reagent channel comprises a reagent pack comprises a fluid reagent, wherein the reagent channel is in fluidic communication with the filter; and
a test strip configured to provide a fluidic communication between the reagent channel and an absorbent pad and support a directional flow of the biological sample and the fluid reagent from the reagent channel to the absorbent pad.
